(19) United States
(12) Patent Application Publication
(10) Pub. No.: US 2010/0023160 A1
(43) Pub. Date: Jan. 28, 2010

(54) CROSS-FAB MATERIAL CONTROL SYSTEM AND CONTROL METHOD THEREOF

(75) Inventors: YU-KUN CHEN, TAIPEI COUNTY (TW); CHIN-HSIAO CHUANG, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., TAOYUAN COUNTY (TW)

(21) Appl. No.: 12/263,680

(22) Filed: Nov. 3, 2008

(30) Foreign Application Priority Data
Jul. 25, 2008 (TW) 97128298

(51) Int. Cl. G06F 7/00; B65H 7/00; B65G 15/00

(52) U.S. Cl. 700/219; 414/222.01; 198/804

(57) ABSTRACT

A cross-fab control system and a method for using the said system are disclosed. The said system comprises a first transport system, a second transport system, a cross-area control system, and a stocker. The first transport system connects the cross-area control system. The stocker connects the second transport system and the cross-area control system. The cross-area control system is utilized to identify Front Opening Unified Pod (FOUP) data on the stocker. By the assistance of the cross-area control system, the first transport system will transport the FOUP to destination through optimize path and avoid FOUP staying on the stocker with no transport command.

### BACKGROUND OF THE INVENTION

1. Field of the Invention

The present invention is related to a system and method for material transport; in particular, to a cross-fab material control system and control method thereof.

2. Description of Related Art

In recent years, the industry has developed the so-called Automated Material Handling System (AMHS) widely applied in semiconductor fabs (or semiconductor fabrication plants) at present days. The AMHS consists of Overhead Hoist Shuttle (OHS), Overhead Hoist Transport (OHT), Rail Guided Vehicle (RGV), and Stocker (STK), thereby semiconductor fabs are able to perform automated wafer transport, allowed to replace manual transport and increase production yield.

As shown in FIG. 1, wherein the system architecture of an automated transport system used in a semiconductor fab of the prior art is illustrated, the automated transport system 100a comprising a Manufacturing Execution System (MES) 101a, a Material Control System (MCS) 102a, and an Automated Material Handling System (AMHS) 103a, wherein the MCS 102a is electrically connected between the MES 101a and the AMHS 103a, the MCS 102a being employed as a communication bridge between the MES 101a and the AMHS 103a; that is, the MES 101a transports a wafer transport message to the MCS 102a, and the MCS 102a further controls the management of the AMHS 103a so as to facilitate wafer transport operations.

In summary, although the automated transport system 100a applied in semiconductor fabs according to the prior art may achieve the objective of automated wafer transport; upon the requirement of cross-fab transport operation, however, it still presents the following drawbacks:

1. since each automated transport system 100a is independently installed at different areas, once any of these automated transport systems 100a fails or enters into a process of maintenance, no other automated mechanism can provide redundant or supportive capability even as there exists an identical system in some other fab;

2. in case of occurrence of malfunction or maintenance operation in the automated transport system 100a installed at an area, this area is forced to stop wafer transport, thus reducing production yield;

3. the automated transport system 100a employed in semiconductor fabs according to the prior art can only perform control and management on wafer transport operations, incapable of further determining the shortest path for such wafer transports so as to enhance efficiency in wafer transport operations.

Accordingly, the inventors of the present invention have considered the aforementioned improvable defects to propose the present invention offering reasonable and effective ameliorations over the disadvantages illustrated supra.

### SUMMARY OF THE INVENTION

The essential objective of the present invention is to provide a cross-fab material control system (MCS) and a control method thereof, which, in addition to various wafer transport systems deployed in different fabs, alternatively installs an independent control system; upon performance of cross-fab transport operations on wafers, the identification of data and position of the wafer placed on a cross-fab transport belt is accomplished through the control system, and transfers the data and position of the wafer transport box to the wafer transport system located in the target fab, allowing the wafer transport system in the target fab to determine the shortest transport path to avoid wafer transport box pause/delay on the transport belt which may cause undesirable reduction in production throughput.

To achieve the above-mentioned objective, the present invention provides a cross-fab material control system, comprising: a cross-fab automated stocker; a cross-fab control system, the cross-fab control system being electrically connected to the cross-fab automated stocker; a first transport integration system, the first transport integration system being electrically connected to the cross-fab control system; and a second transport integration system, the second transport integration system being electrically connected to the first transport integration system and the cross-fab automated stocker.

The present invention provides a control method for the cross-fab material control system, comprising the following steps: a second transport integration system transfers a wafer cross-fab transport message to a cross-fab automated stocker, the cross-fab automated stocker performing a plurality of cross-fab transport operations on a plurality of wafer transport boxes based on the wafer cross-fab transport message; after completion of the cross-fab transport operations on the plurality of wafer transport boxes, the second transport integration system transfers a cross-fab data to a first transport integration system; a cross-fab control system substantiates the completion of the cross-fab transport operations on the plurality of wafer transport boxes, and further notifies and transfers a wafer position data to the first transport integration system; the first transport integration system notifies a first material control system in the first transport integration system based on the cross-fab data so as to perform subsequent transportations after cross-fab transport of the plurality of wafer transport boxes; in case of reception failure of the cross-fab data by the first transport integration system, the cross-fab control system substantiates the completion of the cross-fab transport operations on the plurality of wafer transport boxes, and notifies and transfers the wafer position data to the first material control system; finally, the first material control system operates based on the wafer position data to follow up the cross-fab automated stocker so as to perform subsequent transportations after cross-fab transport of the plurality of wafer transport boxes.

The cross-fab material control system and a control method thereof according to the present invention provide the following beneficial effects:

a system independent of original fab is installed, which can be employed to supplement data and positions of relevant wafer transport boxes to the transport integration systems located in different fabs without affecting the operations of original systems; additionally, upon occurrence of breakdown in the manufacture execution system, the cross-fab material control system according to the present invention can operate independently to control the transport of the wafer transport box.

To facilitate further understanding the features and technical contents of the present invention, references are made to the detailed descriptions and appended drawings of the present invention; however, the appended drawings are simply exemplary and illustrative, rather than being used to restrict the scope of the present invention.

### BRIEF DESCRIPTION OF THE DRAWINGS

FIG. 1 is a system architecture diagram of an automated transport system in a semiconductor fab according to the prior art.

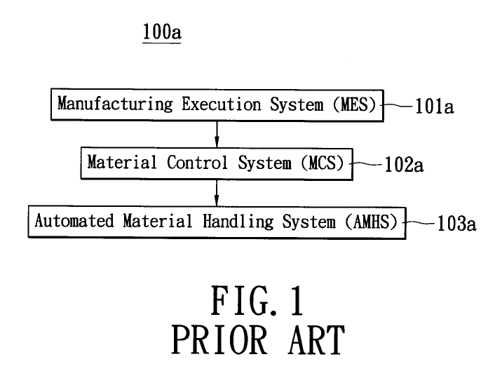

FIG. 2 is a system architecture diagram of a cross-fab material control system according to the present invention.

FIG. 3 is another system architecture diagram of a cross-fab material control system according to the present invention.

FIG. 4 is a step-wise flowchart of the control method for a cross-fab material control system according to the present invention.

FIG. 5 is system communication diagram of the control method for a cross-fab material control system according to the present invention.

### DETAILED DESCRIPTION OF PREFERRED EMBODIMENTS

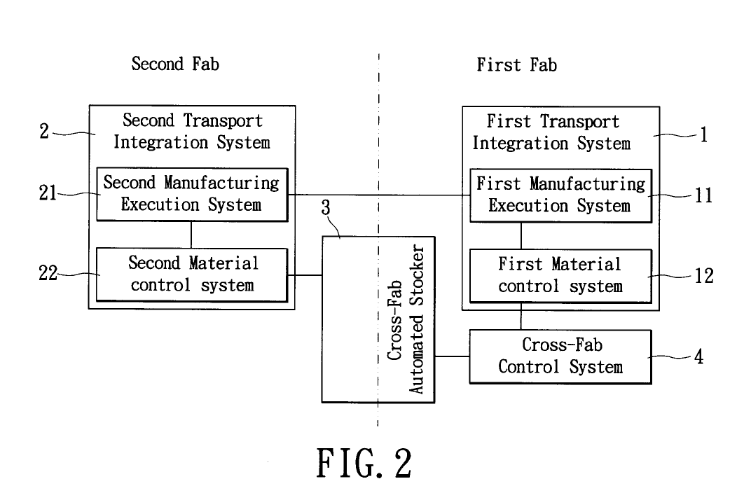

Refer now to FIG. 2, the present invention proposes a cross-fab material control system, comprising: a first transport integration system 1, a second transport integration system 2, a cross-fab automated stocker 3 and a cross-fab control system 4, wherein the second transport integration system 2 electrically connects the first transport integration system 1 and the cross-fab automated stocker 3, and the cross-fab control system 4 is electrically connected between the first transport integration system 1 and the cross-fab automated stocker 3.

The first transport integration system 1 is located in a first fab, which comprises a first manufacturing execution system (MES) 11 and a first material control system 12 (MCS), in which the first manufacturing execution system 11 is electrically connected to the first material control system 12, and the first material control system 12 is further electrically connected to the cross-fab control system 4 to collect various information at scene by means of the first manufacturing execution system 11, and to perform real-time in-situ process control and management so as to provide correct real-time information for data arrangement and analysis, facilitating engineers to make correct decision; additionally, the first manufacturing execution system 11 further instructs the first material control system 12 based on such a decision, in which the first material control system 12 perform integral command and monitoring, acting as a communication bridge between the cross-fab control system 4 and the first manufacturing execution system 11.

The second transport integration system 2 is located in a second fab, the second transport integration system 2 comprising a second manufacturing execution system 21 and a second material control system 22, in which the second material control system 22 is electrically connected between the second manufacturing execution system 21 and the cross-fab automated stocker 3, and the second manufacturing execution system 21 is further electrically connected to the first manufacturing execution system 11, thereby achieving desirable cross-fab data communications.

The cross-fab automated stocker 3 is an automated warehouse for storage of wafers, the cross-fab automated stocker 3 having a plurality of transport belts (not shown) or the plurality of cross-fab automated stocker 3 with one pair of transport belts (not shown), wherein the plurality of transport belts (not shown) respectively lead to different fabs, and a plurality of wafer transport boxes (also known as Front Opening Unified Pod, FOUP) are transported on the plurality of transport belts (not shown) so as to, by using the cross-fab automated stocker 3 as a relay site for wafer transportation, allow wafers coming from different fabs to be transported to the cross-fab automated stocker 3 then furthermore from the cross-fab automated stocker 3 to a destination. Additionally, the aforementioned wafer transport box (not shown) is capable of holding a plurality of wafers (not shown).

The cross-fab control system 4 is independently installed outside from the first transport integration system 1 and the second transport integration system 2, so the cross-fab control system 4 does not affect the operations in the first transport integration system 1 and the second transport integration system 2, wherein the cross-fab control system 4 is used to identify the wafer transport box (not shown) located on the transport belt (not shown) in the cross-fab automated stocker 3, then the cross-fab control system 4 transfers the data and location of the wafer transport box to the first transport integration system 1; next, the first manufacturing execution system 11 of the first transport integration system 1 determines the shortest transport path based on the data and location of the wafer transport box transferred by the cross-fab control system 4 to instruct and control the first material control system 12 to perform transportation of the wafer transport box; additionally, in case that the first manufacturing execution system 11 in the first transport integration system 1 becomes out of order and is not able to control the first material control system 12, the cross-fab control system 4 and the first material control system 12 further take place of the first manufacturing execution system 11, thereby achieving the objective of preventing undesirable pause of the wafer transport box (not shown) on the transport belt (not shown).

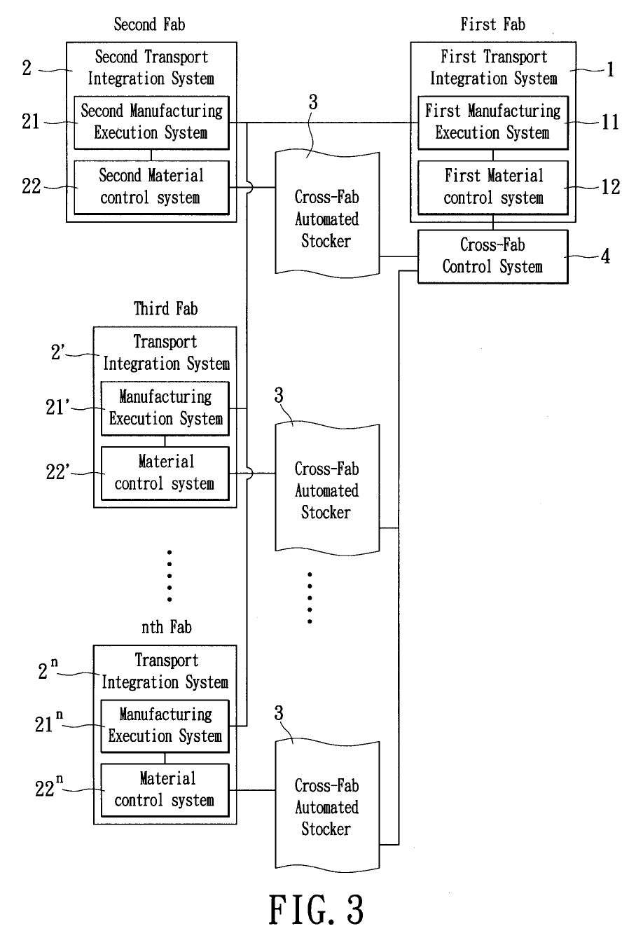

Refer now to FIG. 3, wherein the second transport integration system 2 may be further additively configured as being plural, and the above-referred additively configured transport integration systems 2′, . . . , 2ⁿ may be placed in different fabs. The increased transport integration systems 2′, . . . , 2ⁿ each respectively has a manufacturing execution system 21′, . . . , 21ⁿ as well as a material control system 22′, . . . , 22ⁿ identical to the ones found in the second transport integration system 2, and the said material control system 22′, . . . , 22ⁿ are respectively connected between the said manufacturing execution system 21′, . . . , 21ⁿ, and the cross-fab automated stocker 3, . . . ,3ⁿ, herein the manufacturing execution system 21′, . . . , 21ⁿ, the second manufacturing execution system 21, and the first manufacturing execution system 11 are mutually electrically connected, thereby providing cross-fab data communication; therefore, through the above-mentioned architecture, transport integration systems 2′, . . . , 2ⁿ in multiple fabs can mutually perform data transfer and communication, providing data transfer between fabs, and, by means of the cross-fab control system 4, resolve the issue of pause of wafer transport box (not shown) on the transport belt and undesirable influence on transport efficiency upon breakdown of the manufacturing execution systems 11, 21, 21′, . . . , 21ⁿ.

Furthermore, the embodiments disclosed above have taken wafer transport in a semiconductor fab as examples; wherein the consideration here is that the cross-fab material control system according to the present invention, in addition to wafer transport in a semiconductor fab, may be also applied in material transport operations for general factories or other industries.

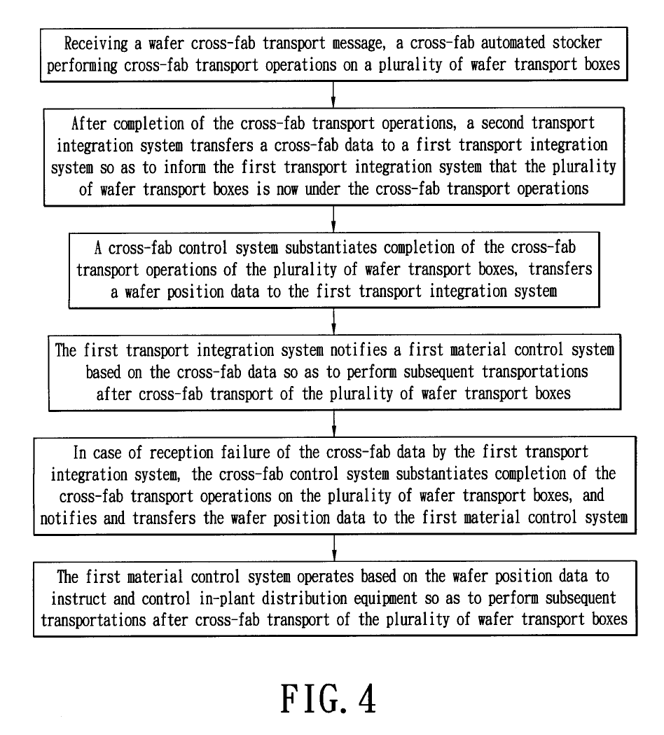

Refer now to FIG. 4, wherein the present invention proposes a control method for a cross-fab material control system, comprising the following steps:

A. receiving a wafer cross-fab transport message, in which the cross-fab automated stocker 3 (conjunctively referring to FIG. 2) performs cross-fab transport operations on a plurality of wafer transport boxes;

B. after completion of the cross-fab transport operations, the second transport integration system 2 transfers a cross-fab data to the first transport integration system 1 so as to inform the first transport integration system 1 that the plurality of wafer transport boxes is now under cross-fab transport operations;

C. the cross-fab control system 4 substantiates that the cross-fab transport operations of the plurality of wafer transport boxes have been completed, then transfers a wafer position data to the first transport integration system 1;

D. the first transport integration system 1 notifies the first material control system 12 based on the cross-fab data to perform subsequent transportations after the cross-fab transport of the plurality of wafer transport boxes;

E. in case of reception failure of the cross-fab data by the first transport integration system 1, the cross-fab control system 4 substantiates the completion of the cross-fab transport operations on the plurality of wafer transport boxes, and notifies and transfers the wafer position data to the first material control system 12;

F. the first material control system 12 operates based on the wafer position data to instruct and control in-plant distribution equipment so as to perform subsequent transportations after cross-fab transport of the plurality of wafer transport boxes.

To facilitate those skilled in the art to appreciate and implement the present invention, herein detailed descriptions of the method according to the present invention are provided, in which when the wafers in the second fab need to be transported to the first fab for tooling process, then first, the second manufacturing execution system 21 builds a wafer cross-fab transport message and transfers the wafer cross-fab transport message to the second material control system 22; next, the second material control system 22 acts as a communication bridge between the second manufacturing execution system 21 and the cross-fab automated stocker 3, transferring the wafer cross-fab transport message to the cross-fab automated stocker 3; subsequently, the cross-fab automated stocker 3 performs cross-fab transportation of a plurality of wafer transport boxes based on the wafer cross-fab transport message.

Upon arrival of the plurality of wafer transport boxes (not shown) from the second fab at the cross-fab automated stocker 3, the second material control system 22 notifies the second manufacturing execution system 21; after reception of such a notification, the second manufacturing execution system 21 transfers the cross-fab data to the first manufacturing execution system 11 of the first transport integration system 1; after reception of the cross-fab data, the first manufacturing execution system 11 detects via the cross-fab data that the plurality of wafer transport boxes (not shown) from the second fab are currently under cross-fab transportation.

When the plurality of wafer transport boxes (not shown) arrive at the first fab, the cross-fab control system 4 detects these wafer transport boxes (not shown) and generates the wafer position data to substantiates that the plurality of wafer transport boxes (not shown) have been cross-fab transported into the first fab from the second fab; after substantiation, the cross-fab control system 4 transfers the wafer position data to the first material control system 12, and the wafer position data is further transferred to the first manufacturing execution system 11 via the first material control system 12.

Upon reception of the wafer position data, the first manufacturing execution system 11 detects via the wafer position data that the cross-fab transport of the plurality of wafer transport boxes has been completed; at this moment, the first manufacturing execution system 11 further instructs and controls the first material control system 12 based on the cross-fab data, and the first material control system 12 instructs and controls in-plant distribution equipment to follow up the performance of subsequent transportations in the first fab after cross-fab transport of the plurality of wafer transport boxes (not shown).

Since the first manufacturing execution system 11 may shut down due to malfunction or maintenance; in this case, it is not possible to receive the cross-fab data transferred by the second manufacturing execution system 21, thus making the first manufacturing execution system 11 incapable of determining whether the plurality of wafer transport boxes (not shown) are currently cross-fab transported from the second fab to the first fab; hence, upon arrival of the plurality of wafer transport boxes (not shown) at the first fab, the cross-fab control system 4 detects the plurality of wafer transport boxes (not shown) and generates the wafer position data to substantiates that the plurality of wafer transport boxes (not shown) have been cross-fab transported into the first fab from the second fab; after substantiation, the cross-fab control system 4 transfers the wafer position data to the first material control system 12.

Finally, the first material control system 12 instructs and controls in-plant distribution equipment based on the wafer position data to follow up the cross-fab automated stocker 3 for performing subsequent transportations in the first fab after cross-fab transport of the plurality of wafer transport boxes.

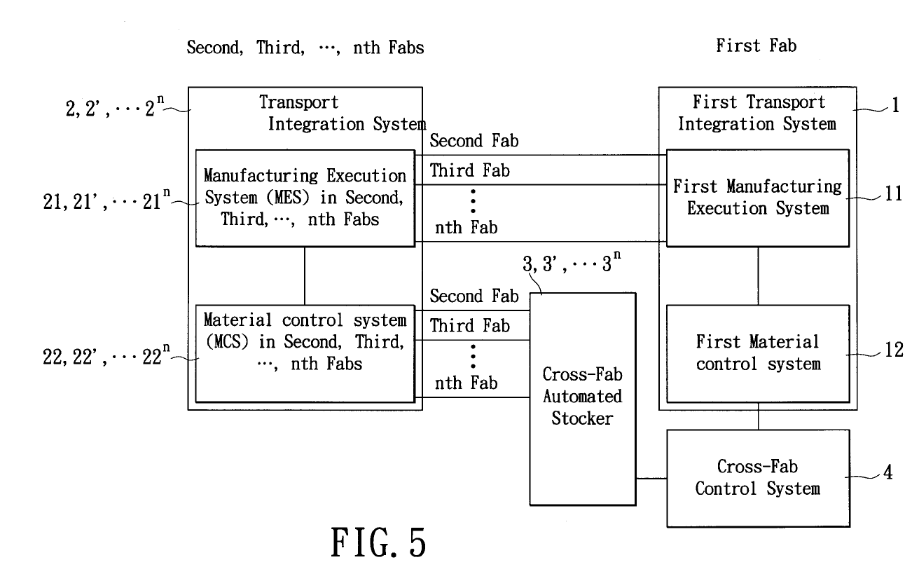

Furthermore, referring conjunctively to FIGS. 3, 4, and 5, in the control method for a cross-fab material control system according to the present invention, the second transport integration system 2 may be further additively configured as being plural, and the above-referred additively configured transport integration systems 2′, . . . , 2ⁿ may be located in different fabs; also, as the control method described above, these transport integration systems 2′, . . . , 2ⁿ located in multiple fabs can mutually perform data transfers and communications to provide cross-fab transport between multiple fabs.

Furthermore, the embodiments disclosed above have taken wafer transport in a semiconductor fab as examples; the consideration here is that the control method for cross-fab material control system according to the present invention, in addition to wafer transport in a semiconductor fab, may be also applied in material transport control operations for general factories or other industries.

The aforementioned descriptions simply illustrate the preferred embodiments of the present invention, rather than being intended to restrict the scope of the present invention to be legally protected; hence, all effectively equivalent changes or modifications made based on the disclosure of the present invention and appended drawings thereof are reasonably deemed to fall within the scope of the present invention delineated by the subsequent claims.

What is claimed is:

1. a cross-fab material control system, comprising:
a cross-fab automated stocker;
a cross-fab control system, the cross-fab control system being electrically connected to the cross-fab automated stocker;
a first transport integration system, the first transport integration system being electrically connected to the cross-fab control system; and
a second transport integration system, the second transport integration system being electrically connected to the first transport integration system and the cross-fab automated stocker.

2. The cross-fab material control system according to claim 1, wherein the cross-fab automated stocker consists of a plurality of transport belts, the plurality of transport belts respectively leading to different fabs, and a plurality of wafer transport boxes being transported on the plurality of transport belts.

3. The cross-fab material control system according to claim 1, wherein the first transport integration system and the second transport integration system are located in different fabs.

4. The cross-fab material control system according to claim 1, wherein the first transport integration system consists of a first manufacturing execution system (MES) and a first material control system (MCS), and the first material control system being electrically connected to the first manufacturing execution system and the cross-fab control system.

5. The cross-fab material control system according to claim 4, wherein the second transport integration system consists of a second manufacturing execution system and a second material control system, the second material control system being electrically connected between the second manufacturing execution system and the cross-fab automated stocker, and the second manufacturing execution system being electrically connected to the first manufacturing execution system.

6. The cross-fab material control system according to claim 1, wherein the second transport integration system is further additively configured as being plural, and the additively configured transport integration systems may be placed in different fabs.

7. The cross-fab material control system according to claim 6, wherein the first transport integration system consists of a first manufacturing execution system (MES) and a first material control system (MCS), and the first material control system being electrically connected to the first manufacturing execution system and the cross-fab control system.

8. The cross-fab material control system according to claim 7, wherein the second transport integration system consists of a second manufacturing execution system and a second material control system, the second material control system being electrically connected between the second manufacturing execution system and the cross-fab automated stocker.

9. The cross-fab material control system according to claim 8, wherein the additively configured transport integration systems each respectively have a manufacturing execution system (MES) and a material control system (MCS) that is the same as the MCS and MES of the second transport integration system, the respective MCS being electrically connected between the respective transport integration system and the cross-fab automated stocker.

10. The cross-fab material control system according to claim 9, wherein the first manufacturing execution system, the second manufacturing execution system, and the manufacturing execution systems in the additively configured transport integration systems are mutually electrically connected.

11. A control method for the cross-fab material control system, comprising the following steps:
a second transport integration system transfers a wafer cross-fab transport message to a cross-fab automated stocker, the cross-fab automated stocker performing cross-fab transport operations on a plurality of wafer transport boxes based on the wafer cross-fab transport message;
after completion of the cross-fab transport operations on the plurality of wafer transport boxes, the second transport integration system transfers a cross-fab data to a first transport integration system;
a cross-fab control system substantiates the completion of the cross-fab transport operations on the plurality of wafer transport boxes, and further notifies and transfers a wafer position data to the first transport integration system;
the first transport integration system notifies a first material control system in the first transport integration system based on the cross-fab data so as to perform subsequent transportations after cross-fab transport of the plurality of wafer transport boxes;
in case of reception failure of the cross-fab data by the first transport integration system, the cross-fab control system substantiates the completion of the cross-fab transport operations on the plurality of wafer transport boxes, and notifies and transfers the wafer position data to the first material control system; finally
the first material control system operates based on the wafer position data to follow up the cross-fab automated stocker so as to perform subsequent transportations after cross-fab transport of the plurality of wafer transport boxes.

12. The control method for the cross-fab material control system according to claim 11, wherein the first transport integration system and the second transport integration system are located in different fabs.

13. The control method for the cross-fab material control system according to claim 11, wherein the first transport integration system further consists of a first manufacturing execution system (MES), the first material control system being electrically connected to the first manufacturing execution system and the cross-fab control system, and the cross-fab control system being electrically connected to the cross-fab automated stocker.

14. The control method for the cross-fab material control system according to claim 13, wherein the second transport integration system consists of a second manufacturing execution system and a second material control system, the second material control system being electrically connected between the second manufacturing execution system and the cross-fab automated stocker, and the second manufacturing execution system being electrically connected to the first manufacturing execution system.

15. The control method for the cross-fab material control system according to claim 14, wherein the second transport integration system transfers the wafer cross-fab transport message to the cross-fab automated stocker, the cross-fab automated stocker performing cross-fab transportation on a plurality of wafer transport boxes based on the wafer cross-fab transport message, whose steps comprising:
the second manufacturing execution system builds the wafer cross-fab transport message and transfers the wafer cross-fab transport message to the second material control system;
the second material control system transfers the wafer cross-fab transport message to the cross-fab automated stocker, and the cross-fab automated stocker performs cross-fab transport of the plurality of wafer transport boxes bases on the wafer cross-fab message.

16. The control method for the cross-fab material control system according to claim 14, wherein after completion of the cross-fab transport of the plurality of wafer transport boxes, the second transport integration system transfers the cross-fab data to the first transport integration system, whose steps comprising:
upon arrival of the plurality of wafer transport boxes at the cross-fab automated stocker, the second material control system notifies the second manufacturing execution system;
after reception of the notification, the second manufacturing execution system further transfers the cross-fab data to the first manufacturing execution system;
upon reception of the cross-fab data, the first manufacturing execution system detects via the cross-fab data that the plurality of wafer transport boxes are currently under cross-fab transport operations.

17. The control method for the cross-fab material control system according to claim 14, wherein the cross-fab control system substantiates the completion of the cross-fab transport of the plurality of wafer transport boxes, and further notifies and transfers the wafer position data to the first transport integration system, whose steps comprising:
the cross-fab control system detects the plurality of wafer transport boxes to substantiate the completion of the cross-fab transport of the plurality of wafer transport boxes;
after substantiation, the cross-fab control system transfers the wafer position data to the first manufacturing execution system via the first material control system.

18. The control method for the cross-fab material control system according to claim 14, wherein the first transport integration system, based on the cross-fab data, notifies the first material control system in the first transport integration system to perform subsequent transportation after cross-fab transport of the plurality of wafer transport boxes, whose steps comprising:
by receiving the wafer position data, the first manufacturing execution system instructs and controls the first material control system based on the cross-fab data;
instructed and controlled by the first manufacturing execution system, the first material control system further notifies and instructs in-plant distribution equipment to perform subsequent transportation after cross-fab transport of the plurality of wafer transport boxes.

19. The control method for the cross-fab material control system according to claim 14, wherein in case of reception failure of the cross-fab data by the first transport integration system, the cross-fab control system substantiates the completion of the cross-fab transport operations on the plurality of wafer transport boxes, and notifies and transfers the wafer position data to the first material control system, whose steps comprising:
the first manufacturing execution system can not receive the cross-fab data transferred from the second manufacturing execution system, unable to detect via the cross-fab data whether or not the plurality of wafer transport boxes are currently under cross-fab transport operations, the cross-fab control system accordingly detects the plurality of wafer transport boxes to substantiate the completion of the cross-fab transport operations of the plurality of wafer transport boxes;
after substantiation, the cross-fab control system transfers the wafer position data to the first manufacturing execution system.

20. The control method for the cross-fab material control system according to claim 14, wherein the first material control system operates, based on the wafer position data, to follow up the cross-fab automated stocker so as to perform subsequent transportations after cross-fab transport of the plurality of wafer transport boxes, whose steps comprising:
the first material control system receives the wafer position data transferred from the cross-fab control system;
the first material control system instructs and controls in-plant distribution equipment to perform subsequent transportation after cross-fab transport of the plurality of wafer transport boxes.
